(19) United States
(12) Patent Application Publication
(10) Pub. No.: US 2019/0200684 A1
(43) Pub. Date: Jul. 4, 2019

(54) MOTORCYCLE ACCIDENT ALERT SYSTEMS AND METHODS OF USING THE SAME

(71) Applicant: Fredrick Ballstaedt, McHenry, IL (US)

(72) Inventor: Fredrick Ballstaedt, McHenry, IL (US)

(21) Appl. No.: 16/298,960

(22) Filed: Mar. 11, 2019

Related U.S. Application Data
(63) Continuation-in-part of application No. 15/855,433, filed on Dec. 27, 2017.

(51) Int. Cl. A41D 1/00; A41D 3/00; A42B 3/04; A41D 13/01; B62J 99/00

(52) U.S. Cl. CPC A41D 1/002; A41D 3/00; A42B 3/046; A42B 3/0453; B62J 2099/008; A41D 13/01; B62J 99/00; A41D 2600/102; A42B 3/044

(57) ABSTRACT

Motorcycle alert systems include a motorcycle, an article of clothing, such as a motorcycle jacket, a helmet, gloves, pants, or other like article of clothing, and a wired or wireless tether connecting the motorcycle to the article of clothing, such that when the motorcycle is in an accident, a signal is sent to the article of clothing, having visual and/or audible signals thereon, causing the article of clothing to visually or audibly alert another as to the location and presence of the motorcyclist wearing the article of clothing. Methods of using the same are further provided

### TECHNICAL FIELD

The present invention relates to motorcycle alert systems. Specifically, the motorcycle alert systems include a motorcycle, an article of clothing, such as a motorcycle jacket, a helmet, gloves, pants, or other like article of clothing, and a wired or wireless tether connecting the motorcycle to the article of clothing, such that when the motorcycle is in an accident, a signal is sent to the article of clothing, having visual and/or audible signals thereon, causing the article of clothing to visually or audibly alert another as to the location and presence of the motorcyclist wearing the article of clothing. Methods of using the same are further provided.

### BACKGROUND

Motorcyclists have enjoyed riding motorcycles for many years. However, motorcycles can be very dangerous on the road, much more dangerous that automobiles, due to various factors. First, a motorcyclist is not caged within a protective passenger structure, and so if in an accident, there is nothing to protect the motorcyclist. An accident can affect a motorcyclist in many ways. For example, the motorcyclist can be hit directly by another vehicle, can get thrown off the motorcycle and land on the ground or another object, can get hit by a vehicle after getting thrown off the motorcycle, etc.

If thrown from a motorcycle, a motorcyclist can be difficult to spot, either by other motorists, or when a search is conducted after an accident. When an accident happens at night, it may be particularly difficult for a motorcyclist to be found, especially if the motorcyclist has been thrown from his motorcycle. And if the motorcyclist is debilitated or unconscious from the crash, it may be particularly difficult for the motorcyclist to be spotted after an accident. This may exacerbate the accident, especially if quick help could prevent permanent damage or even death.

Heretofore, an accident alert system does not generally solve the problem of alerting others to a motorcycle accident and to the location of a motorcyclist that may have been thrown from the motorcycle during the accident. Motorcyclists tend to wear heavy protective clothing, and in some cases attempt to make themselves more visible by having reflective elements thereon, such as on jackets, pants, helmets, or other like articles of clothing. However, reflective elements are typically only useful when a light is shining directly thereon, and if a motorcyclist has been thrown a great distance, he or she may be in complete darkness where reflective elements will not help.

There are articles of clothing that have lights embedded therein. Today, cheap and bright lights in the form of LEDs can be manufactured into articles of clothing, and these lights can be activated to alert others. However, these articles of clothing are typically for aesthetic purposes, not to alert others to an accident. As such, they are typically activated when desired by the wearer via a switch on the clothing. However, if a motorcyclist is in an accident, he or she may not have time or the ability to activate the lights within the clothing, especially if unconscious or incapacitated.

A need, therefore, exists for an improved accident alert system and methods of using the same. Specifically, a need exists for an improved accident alert system and methods of using the same that provides important visual and/or audible alert information to others after an accident has occurred to a motorcyclist.

Moreover, a need exists for an improved accident alert system and methods of using the same that automatically provides a visual and/or audible signal at the time and/or after an accident has occurred. In addition, a need exists for an improved accident alert system and methods of using the same that detects when an accident has occurred to a motorcyclist and activates the visual and/or audible alert system.

Further, a need exists for an improved accident alert system and methods of using the same that provides a wired or wireless connection between a motorcycle and an article of clothing worn by a motorcyclist. Still further, a need exists for an improved accident alert system and methods of using the same that detects when an accident occurs and sends a signal from the motorcycle to the article of clothing thereby activating visual and/or audible alerts.

### SUMMARY OF THE INVENTION

The present invention relates to motorcycle alert systems. Specifically, the motorcycle alert systems include a motorcycle, an article of clothing, such as a motorcycle jacket, a helmet, gloves, pants, or other like article of clothing, and a wired or wireless tether connecting the motorcycle to the article of clothing, such that when the motorcycle is in an accident, a signal is sent to the article of clothing, having visual and/or audible signals thereon, causing the article of clothing to visually or audibly alert another as to the location and presence of the motorcyclist wearing the article of clothing. Methods of using the same are further provided.

To this end, in an embodiment of the present invention, a motorcycle accident alert apparatus is provided. The apparatus comprises: an article of clothing configured to be worn by a motorcyclist while riding a motorcycle, the article of clothing comprising at least one of a visual indicator and an audible indicator; and a tether configured to be connected to a motorcycle causing the article of clothing and the motorcycle to share a connection, wherein disconnection of the connection between the article of clothing and the motorcycle causes the at least one of the visual indicator and the audible indicator to activate.

In an embodiment, the visual indicator comprises at least one visible light on the article of clothing.

In an embodiment, the audible indicator is selected from the group consisting of a speaker, a buzzer, a horn, and combinations thereof.

In an embodiment, the tether comprises a physical line physically connecting the article of clothing to the motorcycle.

In an embodiment, the tether is wireless.

In an embodiment, the tether comprises a proximity sensor configured to detect a distance between the motorcyclist and the motorcycle.

In an embodiment, the at least one of the visual indicator and the audible indicators is activated when the distance between the motorcyclist and the motorcycle is greater than a predetermined amount.

In an alternate embodiment of the present invention, a motorcycle accident alert system is provided. The system comprises: a motorcycle ridden by a motorcyclist; an article of clothing configured to be worn by the motorcyclist while riding the motorcycle, the article of clothing comprising at least one of a visual indicator and an audible indicator; and a tether configured to be connected to a motorcycle causing the article of clothing and the motorcycle to share a connection, wherein disconnection of the connection between the article of clothing and the motorcycle causes the at least one of the visual indicator and the audible indicator to activate.

In an embodiment, the visual indicator comprises at least one visible light on the article of clothing.

In an embodiment, the audible indicator is selected from the group consisting of a speaker, a buzzer, a horn, and combinations thereof.

In an embodiment, the tether comprises a physical line physically connecting the article of clothing to the motorcycle.

In an embodiment, the tether is wireless.

In an embodiment, the tether comprises a proximity sensor configured to detect a distance between the motorcyclist and the motorcycle.

In an embodiment, the at least one of the visual indicator and the audible indicators is activated when the distance between the motorcyclist and the motorcycle is greater than a predetermined amount.

In yet another alternate embodiment of the present invention, a method of sensing a motorcycle accident and triggering an alert is provided. The method comprises the steps of: providing a motorcycle ridden by a motorcyclist; providing an article of clothing configured to be worn by the motorcyclist while riding the motorcycle, the article of clothing comprising at least one of a visual indicator and an audible indicator; and connecting a tether between the article of clothing and the motorcycle causing the article of clothing and the motorcycle to share a connection, wherein disconnection of the connection between the article of clothing and the motorcycle causes the at least one of the visual indicator and the audible indicator to activate.

In an embodiment, the visual indicator comprises at least one visible light on the article of clothing, and the method further comprises the step of: activating the at least one visible light on the article of clothing when the connection is disconnected.

In an embodiment, the audible indicator is selected from the group consisting of a speaker, a buzzer, a horn, and combinations thereof.

In an embodiment, the tether comprises a physical line physically connecting the article of clothing to the motorcycle.

In an embodiment, the tether is wireless.

In an embodiment, the tether comprises a proximity sensor configured to detect a distance between the motorcyclist and the motorcycle.

It is, therefore, an advantage and objective of the present invention to provide an improved accident alert system and methods of using the same.

Specifically, it is an advantage and objective of the present invention to provide an improved accident alert system and methods of using the same that provides important visual and/or audible alert information to others after an accident has occurred to a motorcyclist.

Moreover, it is an advantage and objective of the present invention to provide an improved accident alert system and methods of using the same that automatically provides a visual and/or audible signal at the time and/or after an accident has occurred.

In addition, it is an advantage and objective of the present invention to provide an improved accident alert system and methods of using the same that detects when an accident has occurred to a motorcyclist and activates the visual and/or audible alert system.

Further, it is an advantage and objective of the present invention to provide an improved accident alert system and methods of using the same that provides a wired or wireless connection between a motorcycle and an article of clothing worn by a motorcyclist.

Still further, it is an advantage and objective of the present invention to provide an improved accident alert system and methods of using the same that detects when an accident occurs and sends a signal from the motorcycle to the article of clothing thereby activating visual and/or audible alerts.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates a side view of a motorcyclist riding a motorcycle in an embodiment of the present invention.

FIG. 2 illustrates a front view of an exemplary article of clothing in an embodiment of the present invention.

FIG. 3 illustrates a smart phone proximity alert sensor in association with a motorcycle and an article of clothing in an embodiment of the present invention.

### DETAILED DESCRIPTION OF THE PRESENTLY PREFERRED EMBODIMENTS

The present invention relates to motorcycle alert systems. Specifically, the motorcycle alert systems include a motorcycle, an article of clothing, such as a motorcycle jacket, a helmet, gloves, pants, or other like article of clothing, and a wired or wireless tether connecting the motorcycle to the article of clothing, such that when the motorcycle is in an accident, a signal is sent to the article of clothing, having visual and/or audible signals thereon, causing the article of clothing to visually or audibly alert another as to the location and presence of the motorcyclist wearing the article of clothing. Methods of using the same are further provided.

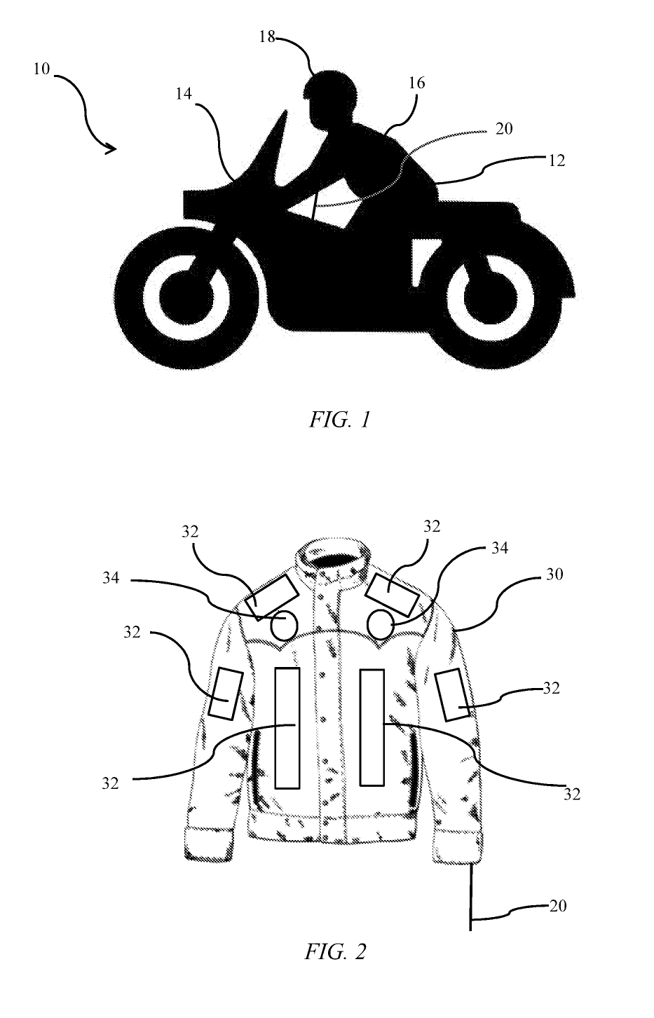

Now referring to the figures, wherein like numerals refer to like parts, FIG. 1 illustrates a motorcycle alert system 10 in an embodiment of the present invention. The system 10 includes a motorcyclist 12 and a motorcycle 14. The motorcyclist 12 further has articles of clothing 16 thereon, and a helmet 18. An article of clothing 16, such as a jacket, pants, and/or the helmet 18 may be tethered to the motorcycle 14 via tether 20. The tether 20 may be a physical connection, such as a wire, cord, or other like line, or may be a “wireless” tether, as described in more detail below.

It should be noted that although the present invention is described herein with reference to a motorcycle and a motorcyclist, it may apply in other situations and applications, including bicycles and bicyclists, scooters, Segway® riders, and other like users of powered or unpowered vehicles. In addition, aspects of the invention may be utilized in situations where an individual is not using a vehicle, such as a pedestrian, a jogger, or other like user, as described in more detail below.

If the tether 20 is a physical connection, such as a wire, cord or other like line, then it may be physically connected to the motorcycle so that it can be pulled away and disconnected from the motorcycle thereby remaining with the motorcycle. Alternately, the tether 20 may break away from the article of clothing 16 and remain with the motorcycle 14. In either case, if the tether 20 is physically disconnected from either the motorcycle 14 and/or from the article of clothing 16, a signal may be detected by a controller (not shown) that activates a plurality of visual and/or audible indicators on the article of clothing and/or the motorcycle.

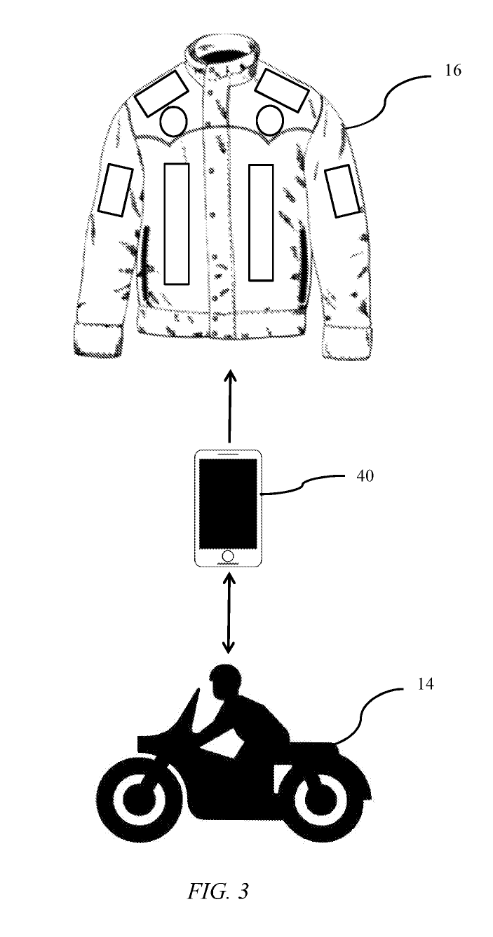

Preferably, the visual and/or audible indicators are provided on an article of clothing, as illustrated in FIG. 2, showing a jacket 30 that a motorcyclist may wear and the tether 20 extending from a sleeve of the jacket 30. The jacket 30 may further have a plurality of visual indicators 32, preferably lights, preferably LED lights, such as strips of LED lights or other like visual indicators that may be viewable from a distance therefrom. The plurality of visual indicators 32 may be placed in any location of the jacket 30, or any other article of clothing worn by a motorcyclist, including the helmet 18 thereof. Likewise, the jacket may have a plurality of audible indicators 34, such as audio speakers, buzzers, horns, or other like audible indicators that may provide an audible signal that may be heard over a distance.

Thus, when the tether 20 breaks away from either the motorcycle, the article of clothing or both, such as during a crash of the motorcycle where the motorcyclist is separated from the motorcycle, the visual indicators 32 and/or the audible indicators 34 may be automatically activated, thereby allowing the article of clothing and, therefore, the motorcyclist to be seen and/or heard over a distance.

For example, a motorcyclist may get into an accident late at night on a rural road without street lights. During the accident, the motorcyclist may be thrown from his or her motorcycle, and may be lying unconscious in a field, difficult to see from the roadside where the accident took place. Because the motorcyclist was thrown from his or her motorcycle, the tether 20 broke away from the motorcycle, the article of clothing, or both, and activated the visual indicators 32 and/or the audible indicators 34.

Although FIG. 2 illustrates a jacket having visual and/or audible indicators thereon, it should be noted that any article of clothing 16 or the helmet 18 may have visual and/or audible indicators thereon, allowing the motorcyclist to be found more easily after a crash where the motorcyclist becomes separated from the motorcycle.

In addition, visual and audible indicators on the motorcycle 14 may also be triggered by a disconnection of the tether 20, thereby alerting others not only to the location of the motorcyclist 20 in the event of a crash, but also to the presence of a crashed motorcycle, which may also be difficult to find, or may be in a roadway that is difficult to see by oncoming traffic. The visual indicators may simply be the lights on the motorcycle 14 that may be configured to flash rapidly and/or be brighter than normal. The audible indicators may simply be the horn of the motorcycle 14 that may be configured to blare as an alert in the event of a crash and/or if the tether 20 is broken.

The system 10 of the present invention may be activated or de-activated as desired by a user thereof. For example, after riding uneventfully, a motorcyclist may wish to dismount his or her motorcycle and leave the same for a period of time. Thus, the motorcyclist may de-activate the alert system 10 so that dismounting and leaving the motorcycle do not cause the visible indicators 32 and/or audible indicators 34 to activate. Likewise, when the motorcyclist 12 wishes to ride further, he or she may connect the tether 20 from the article of clothing 16 and/or the helmet 18 to the motorcycle 14, and the system 10 may become activated.

In an embodiment of the present invention, the system 10 may be activated by a triggering event coupled with acceleration and/or continued high speed motion of the motorcyclist. The triggering event may preferably be the disconnection of the tether 20, whether the tether is a physical connection or an electronic connection, as described herein. When the tether 20 is disconnected, the acceleration and/or the continued high speed motion of the motorcyclist may indicate to the system 10 that the motorcyclist has been thrown from his or her motorcycle. Specifically, the disconnection of the tether 20 may indicate that the motorcyclist may be separated from his or her motorcycle, yet the acceleration and/or continued high speed motion that may also be detected by the system 10 may indicate that the motorcyclist is still moving. Therefore, these two indicators may indicate that the motorcyclist has been thrown from his or her motorcycle. Thus, a false alarm is prevented, wherein the false alarm is simply the motorcyclist stopping his or her motorcycle and walking therefrom, which would be an indication that an accident has not occurred. In such a case, the tether 20 may be disconnected, but the lack of acceleration or continued high speed motion may indicate that the motorcyclist has not been thrown from the motorcycle, but merely as walked away from it.

The acceleration or continued high speed motion detected by the system 10 that may indicate that a motorcyclist has been thrown from his or her motorcycle may be of a kind and degree that separates it from simply walking away from the motorcycle. For example, if the system 10 detects that the motorcycle is moving at 40 mph, and thereafter detects that a motorcyclists tether 20 is disconnected and detects that the motorcyclist is still traveling at 40 mph or some pre-determined percentage of 40 mph, the system 10 may trigger the alarms, as described herein, because the system 10 may thus determine that the motorcyclist has been thrown from his or her motorcycle and is involved in an accident.

In an alternate embodiment of the present invention, the system 10 of the present invention may include a ripcord or pull cord that may be attached to the article of clothing 16, the helmet 18, or other like wearable apparatus that may trigger the visible and/or audible indicators thereon. Thus, a user may manually trigger the visual and/or audible alerts as needed or desired. This may be useful for a situation where a crash occurs but the motorcyclist does not become separated from his or her motorcycle to trigger the visible or audible indicators automatically. In addition, a manual system may be utilized in situations where the user is not using a vehicle, such as a motorcycle, such as a jogger, streetwalker or other individual that may be struck by a vehicle and wishes to alert others to his or her presence after the accident, or after a user has a medical emergency, such as a heart attack or the like. The ripcord or pull cord may be located in any location on the article of clothing that may be easily accessible to a user thereof.

The tether 20 may alternatively be a wireless connection between the motorcyclist and the motorcycle. A wireless connection may be established between, for example, an article of clothing 16 and/or the helmet 18 and the motorcycle 14, such that proximity away from the motorcycle 14 may activate the visual and/or audible indicators. Thus, if a motorcyclist 12 is thrown from his or her motorcycle 14, the wireless connection may be “severed” based on the proximity of the motorcyclist 12 to the motorcycle 14 or the proximity of the motorcyclist to the motorcycle may be measured and may exceed a predefined distance; the visual and/or audible indicators may be activated on the article of clothing 16 and/or the helmet 18. Preferably, the wireless tether 20 may be attached to or otherwise associated with the article of clothing 16. For example, a control box may be contained within the jacket 30 that may establish a wireless connection to the motorcycle, and may detect when the controller and the jacket, and hence, the motorcyclist, is a particular distance from the motorcycle.

The tether 20 may also be coupled with sensors and/or accelerometers that detect crashes and/or sudden accelerations, such as when a motorcyclist is thrown from his or her motorcycle. The sensors and/or accelerometers may be contained within the article of clothing, or on a separate device, such as a smart phone, as detailed below.

In an exemplary embodiment illustrated in FIG. 3, the tether 20 may be a proximity sensor generated between a smart phone 40 that is carried by the motorcyclist 12 and the motorcycle 14 that may trigger a signal to control visual indicators 32 and audible indicators 34 on a jacket 30, helmet 18, or other article of clothing 16 or the like. The smart phone may further have an accelerometer or other motion detector that may record a sudden increase in acceleration and a disconnection of the tether 20 between the motorcyclist 12 and the motorcycle 14. When both a sudden acceleration and a disconnection of the tether 20 form the motorcycle are detected, a controller within the article of clothing 16 or helmet 18 may cause the visual indicators 32 and/or the audible indicators 34 to activate.

Likewise, the system 10 of the present invention may send an alert to others and/or to an accident report system, such as 911, informing the same that an accident has happened or appears to have happened. Thus, when the system 10 senses an unplanned disconnection of the tether 20, the system 10 may trigger the visual and audible indicators and may further alert others that a crash has occurred. For example, if the tether 20 is controlled by a smart phone, then the smart phone may send a signal, such as place a phone call, send a text message, or other like alert, to others' smart phones indicating the crash. This may allow others to be alerted to the emergency situation.

In addition, a location beacon or location finder may be activated when the tether 20 is disconnected, which may be picked up by others and may help in finding the user after a crash. Thus, the location beacon or finder may be read by others on their smart phones, which may be displayed on a map or with directions to help find the motorcyclist 12. If the controller of the tether 20 is a smart phone, a location finder app of the smart phone may be automatically activated, alerting others to the motorcyclists' position on a map. This, coupled with the motorcyclists' visual and/or audible indicators may allow others to easily find the motorcyclist 12.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are non-limiting, and it should be noted that claim limitations presented herein are not meant to describe the invention as a whole. Moreover, the invention illustratively disclosed herein suitably may be practiced in the absence of any element which is not specifically disclosed herein.

I claim:

1. A motorcycle accident alert apparatus comprising:
an article of clothing configured to be worn by a motorcyclist while riding a motorcycle, the article of clothing comprising at least one of a visual indicator and an audible indicator;
a tether configured to be connected to the motorcycle causing the article of clothing and the motorcycle to share a connection; and
a motion sensor associated with the motorcyclist, wherein disconnection of the connection between the article of clothing and the motorcycle and detection of the motion sensor of continued high speed motion causes the at least one of the visual indicator and the audible indicator to activate.

2. The motorcycle accident alert apparatus of claim 1 wherein the visual indicator comprises at least one visible light on the article of clothing.

3. The motorcycle accident alert apparatus of claim 1 wherein the audible indicator is selected from the group consisting of a speaker, a buzzer, a horn, and combinations thereof.

4. The motorcycle accident alert apparatus of claim 1 wherein the tether comprises a physical line physically connecting the article of clothing to the motorcycle.

5. The motorcycle accident alert apparatus of claim 1 wherein the tether is wireless.

6. The motorcycle accident alert apparatus of claim 5 wherein the tether comprises a proximity sensor configured to detect a distance between the motorcyclist and the motorcycle.

7. The motorcycle accident alert apparatus of claim 6 wherein the at least one of the visual indicator and the audible indicator is activated when the distance between the motorcyclist and the motorcycle is greater than a predetermined amount.

8. A motorcycle accident alert system comprising:
a motorcycle ridden by a motorcyclist;
an article of clothing configured to be worn by the motorcyclist while riding the motorcycle, the article of clothing comprising at least one of a visual indicator and an audible indicator;
a tether configured to be connected to the motorcycle causing the article of clothing and the motorcycle to share a connection; and
a motion sensor associated with the motorcyclist, wherein disconnection of the connection between the article of clothing and the motorcycle and detection of the motion sensor of continued high speed motion causes the at least one of the visual indicator and the audible indicator to activate.

9. The motorcycle accident alert system of claim 8 wherein the visual indicator comprises at least one visible light on the article of clothing.

10. The motorcycle accident alert system of claim 8 wherein the audible indicator is selected from the group consisting of a speaker, a buzzer, a horn, and combinations thereof.

11. The motorcycle accident alert system of claim 8 wherein the tether comprises a physical line physically connecting the article of clothing to the motorcycle.

12. The motorcycle accident alert system of claim 8 wherein the tether is wireless.

13. The motorcycle accident alert system of claim 12 wherein the tether comprises a proximity sensor configured to detect a distance between the motorcyclist and the motorcycle.

14. The motorcycle accident alert apparatus of claim 13 wherein the at least one of the visual indicator and the audible indicator is activated when the distance between the motorcyclist and the motorcycle is greater than a predetermined amount.

15. A method of sensing a motorcycle accident and triggering an alert comprising the steps of:
providing a motorcycle ridden by a motorcyclist;
providing an article of clothing configured to be worn by the motorcyclist while riding the motorcycle, the article of clothing comprising at least one of a visual indicator and an audible indicator;
connecting a tether between the article of clothing and the motorcycle causing the article of clothing and the motorcycle to share a connection, wherein disconnection of the connection between the article of clothing and the motorcycle causes the at least one of the visual indicator and the audible indicator to activate; and
providing a motion sensor associated with the motorcyclist;
automatically activating the at least one of the visual indicator and the audible indicator when the connection between the article of clothing and the motorcycle is disconnected and the motion sensor detects continued high speed motion.

16. The method of claim 15 wherein the visual indicator comprises at least one visible light on the article of clothing, and the method further comprises the step of:
activating the at least one visible light on the article of clothing when the connection is disconnected and the motion sensor detects continued high speed motion.

17. The method of claim 15 wherein the audible indicator is selected from the group consisting of a speaker, a buzzer, a horn, and combinations thereof.

18. The method of claim 15 wherein the tether comprises a physical line physically connecting the article of clothing to the motorcycle.

19. The method of claim 15 wherein the tether is wireless.

20. The method of claim 19 wherein the tether comprises a proximity sensor configured to detect a distance between the motorcyclist and the motorcycle.
